(19) United States
(12) Patent Application Publication
(10) Pub. No.: US 2008/0202414 A1
(43) Pub. Date: Aug. 28, 2008

(54) METHODS AND DEVICES FOR COATING AN INTERIOR SURFACE OF A PLASTIC CONTAINER

(75) Inventors: Min Yan, Ballston Lake, NY (US); Ahmet Gun Erlat, Clifton Park, NY (US); Marc Schaepkens, Medina, OH (US); Tae Won Kim, San Jose, CA (US); Paul Alan McConnelee, Schenectady, NY (US); Matthew Aaron Pellow, Stanford, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/678,215

(22) Filed: Feb. 23, 2007

(51) Int. Cl. B05B 5/12

(52) U.S. Cl. 118/622; 427/230; 427/569

(57) ABSTRACT

Methods and devices for coating an interior surface of a container using ICPECVD are provided. In one embodiment, a method of coating an interior surface of a container comprises: depositing a barrier film on the interior surface of the container using inductively coupled plasma-enhanced chemical-vapor deposition.

### BACKGROUND

This disclosure relates generally to barrier coatings and, more specifically, to methods and devices for coating an interior surface of a plastic container with a barrier film.

Glass has been widely used to make containers for health care, food, and cosmetic applications. However, owing to its high weight and tendency to shatter, replacements for glass have been sought. Polymers, especially plastics, offer the advantages of being lightweight, rugged, and easy to fabricate, among others. Plastics are commonly used as glass alternatives in the food packaging industry. However, bare plastics fail to meet certain requirements to be eligible as glass alternatives in the heath care industry. In particular, they lack the ability to resist the permeation of gases and chemicals such as oxygen and moisture into and through the plastic. Thus, it has become common practice to place a barrier coating on the interiors of plastic containers to serve as a barrier to chemicals and gases.

Unfortunately, health care containers often are small in size (e.g., having diameters less than 2 inches) and have high aspect ratios. Therefore, currently employed coating techniques such as sputtering, evaporation, and plasma-enhanced chemical-vapor deposition can fail to form a relatively uniform barrier coating on the interior surfaces of such containers. Further, these coating techniques are commonly performed in relatively large vacuum chambers. Not only are such vacuum chambers expensive, their coating performance undesirably deteriorates with continued use. This deterioration is due to a build-up of a film on the inside wall of the vacuum chamber, which flakes off and becomes embedded in the coating being formed. To avoid such coating contamination, the operation of the vacuum chamber can be shut down periodically to clean the inside wall of the chamber. The combined costs of the down-time and the cleaning process can be very high.

A need therefore exists for improved methods and devices for coating an interior surface of a container such as a plastic container.

### SUMMARY

Disclosed herein are methods and devices for coating an interior surface of a container. In one embodiment, a method of coating an interior surface of a container comprises: depositing a barrier film on the interior surface of the container using inductively coupled plasma-enhanced chemical-vapor deposition.

In another embodiment, a method of coating an interior surface of a container comprises: depositing a barrier film within a deposition chamber, wherein a hollow interior portion of the container is the deposition chamber.

In yet another embodiment, a device for concurrently coating interior surfaces of a plurality of containers comprises: an array of plasma sources, wherein each plasma source comprises an inlet conduit for injecting reactants into each container, an outlet conduit for pumping gas from said each container, and a conductive coil coupled to a radio frequency power supply.

### BRIEF DESCRIPTION OF THE DRAWINGS

Referring now to the Figures, which are exemplary embodiments, and wherein the like elements are numbered alike:

FIG. 1 is a side plan view of a device for coating an interior surface of a container using inductively coupled plasma-enhanced chemical-vapor deposition (ICPECVD).

FIG. 2 is a side plan view of an embodiment of the inlet conduit of the device for coating an interior surface of a container, wherein the inlet conduit has holes in its wall for uniform gas diffusion.

FIG. 3 is a side plan view of a device comprising an array of plasma sources for coating the interior surfaces of a plurality of containers using ICPECVD.

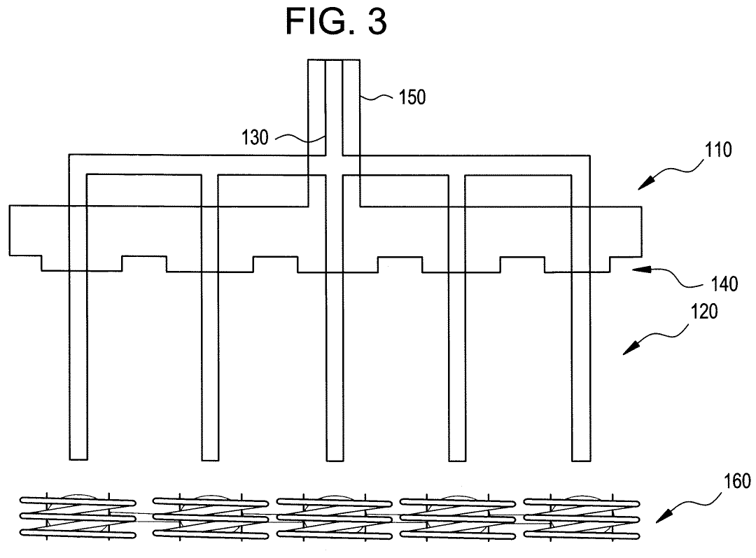

### DETAILED DESCRIPTION

Methods and devices for coating the interior surface of a container using ICPECVD are described herein. As used herein, a “container” is an object that has an interior hollow portion for holding liquids and/or solids. The container can be formed from a plastic such as polycarbonate, polyethylene terephtalate, or polypropylene. The shape of the container can vary depending on its application. For health-care applications, the container could be, for example, a vial, a tube, or a bottle. It could be used for blood delivery, drug delivery, fluid delivery, and so forth.

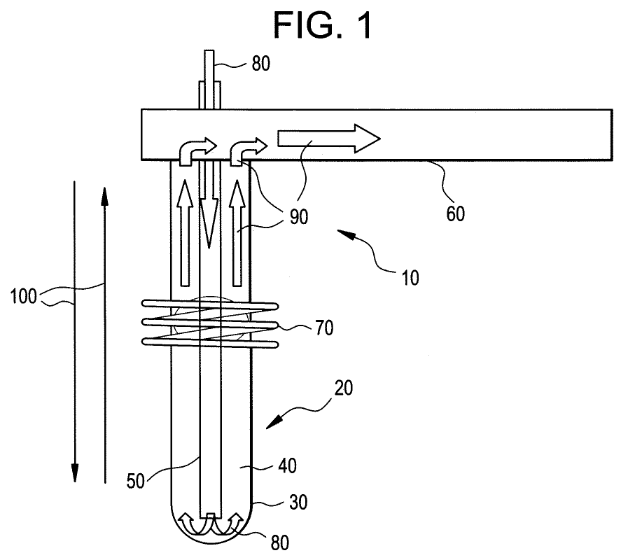

Turning to FIG. 1, an embodiment of a device 10 for coating the interior surface of a container 20 using ICPECVD is shown. The container 20 includes a body 30 and an interior hollow portion 40, which serves as the deposition chamber during the coating procedure. The device 10, also called a plasma source, includes an inlet conduit 50 for delivering reactant gases to container 20, an outlet conduit 60 for removing gases from container 20, and a conductive coil 70 coupled to a radio frequency (RF) power supply and intermediate circuitry. The outlet conduit 60 can be in gaseous communication with a pumping system (not shown), allowing a vacuum to be pulled on interior hollow portion 40 when needed so that it can serve as the deposition chamber. Conductive coil 70 can be made of a metal such as copper. It can be wound into a spiral or a series of concentric rings. The interior of coil 70 can be hollow to allow a cooling fluid such as water to flow through it.

In an embodiment, an interior surface of container 20 may be coated by first positioning device 10 such that conductive coil 70 surrounds the body 30 of container 20. Also, inlet conduit 50 and outlet conduit 60 are positioned such that they are in gaseous communication with the interior hollow portion 40 of container 20. The container 20 can be held in a manner that would allow for this positioning of device 10. For example, the base of container 20 may be sized to fit within a holder designed to hold container 20 in an upright position. The outlet conduit 60 is in gaseous communication with a pumping system (not shown) and allowing a vacuum to be pulled on interior hollow portion 40. Since the container 20 has atmosphere pressure outside body 30 and vacuum inside hollow portion 40, container 20 can be attached to device 10 automatically by pressure difference without using a base. As indicated by arrows 80, pre-selected reactive gases (i.e., plasma precursors) and, optionally, a carrier gas can be fed to the interior hollow portion 40 of container 20 via inlet conduit 50. In an embodiment in which the barrier coating being formed is silicon-oxy-nitride, the reactive gases can include, for example, silane (SiH₄), an oxygen-containing gas such as oxygen (O₂), and a nitrogen-containing gas such as ammonia (NH₃). Examples of suitable carrier gases include but are not limited to argon, helium, nitrogen and other inert gases. The gases can be pumped into container 20 at a flow rate of about 1 standard cubic centimeters per minute (sccm) to about 10,000 sccm. The pressure within container 20 can be at about 1 milliTorr to about 1,000 milliTorrs. The temperature within container 20 can be less than about 100° C. This temperature can be controlled by performing the coating process in a temperature modulated chamber.

After pumping gases into container 20, RF power can be supplied to conductive coil 70, causing the RF power to be coupled to the reactive gases within container 20. The RF power can range from about 1 watt to about 10,000 watts. The cooling fluid can be run through conductive coil 70 to prevent it from overheating. As a result of the coupling, a relatively dense plasma is formed within container 20. Thus, the gas molecules therein become excited, break apart to form radicals, react with preferred radical species, and deposit upon the interior surface of container 20. As indicated by arrows 100, the conductive coil 70 can be moved back and forth along the entire length of body 30 of container 20 in a direction parallel to a central axis of container 20. This movement of conductive coil 70 helps ensure that a barrier film is deposited along the entire interior surface of container 20. Alternatively, the length of conductive coil 70 can be as long as container 20 to cause the plasma to form across the entire length of container 20. The exhaust gas remaining in container 20 can be pumped out through outlet conduit 60, as indicated by arrows 90.

In one embodiment, the barrier film deposited on the interior surface of container 20 is a relatively dense silicon-oxy-nitride film. It can have a thickness of about 10 nanometers (nm) to about 1,000 nm, more specifically about 20 nm to about 100 nm. The barrier film serves as a diffusion barrier, i.e., it blocks the diffusion of gas molecules such as oxygen through it, and thus protects content stored in container 20 from degradation caused by, e.g., oxidization. The barrier film can also block the migration of liquid molecules through it, and thus protects container 20 from being penetrated by whatever fluid is stored therein, such as blood. The barrier film has a very low water transmission rate of less than about 0.5 grams(g)/meters(m)²/day.

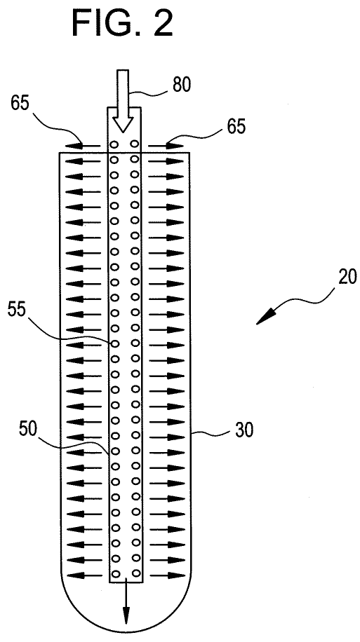

In an embodiment illustrated in FIG. 2, the inlet conduit 50 of device 10 can have holes 55 in its wall to provide for more uniform gas diffusion inside container 20. Arrows 65 illustrate the flow of gas from holes 55 into container 20. The size and distribution density of holes 55 can be varied to ensure uniform gas diffusion and uniform coating deposition.

In accordance with another embodiment, the interior surfaces of a plurality of containers can be coated at the same time, enabling high throughput production of barrier films. An embodiment of a device for concurrently coating multiple containers using ICPECVD is depicted in FIG. 2. The device includes an array of plasma sources 110 comprising an array of inlet conduits 120 for delivering gases to several containers at the same time. The inlet conduits are all connected to a central conduit 130 where pre-selected gases can be supplied. Each inlet conduit 120 can comprise a plurality of holes to provide for gas distribution like those shown in FIG. 2. The array of plasma sources 100 also include an array of outlet conduits 140 for removing gas from multiple containers at the same time and reducing the pressures within those containers in preparation of performing ICPECVD. The outlet conduits 140 are all connected to a central conduit 150 that is in gaseous communication with a pumping system. The array of plasma sources 100 further include an array of conductive coils 160 electrically coupled to an RF power source. Although not shown, the array of conductive coils 160 can be positioned using a mechanical arm that holds all of the coils.

The use of ICPECVD to coat the interior surface of a container as described herein has various advantages. The high density plasma can be created at relatively low temperatures and at relatively high deposition rates, enabling high throughput. As such, the barrier film can be produced on the interior surface of a plastic container without being concerned that the deposition process temperature could melt the plastic. Further, the use of the interior hollow portion of the container as the deposition chamber eliminates the expense associated with using a relatively large vacuum chamber like that commonly employed for other deposition processes. The need for a large capacity pumping system is also eliminated. Moreover, since the deposition takes place within the container itself, there is no longer a problem with the formation of a coating on the walls of the deposition chamber that could flake off and contaminate ensuing coatings.

### EXAMPLES

The following non-limiting examples further illustrate the various embodiments described herein.

A bare polycarbonate sheet having a thickness of 1.5 millimeters and a water vapor transmission rate (WVTR) of about 2 g/m²/day was obtained. A dense silicon-oxy-nitride film was deposited on the surface of the sheet using an ICPECVD reactor. This barrier film exhibited a WVTR of only 0.1 g/m²/day, making it suitable for health care applications.

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “up to about 25 wt. %, or, more specifically, about 5 wt. % to about 20 wt. %,” is inclusive of the endpoints and all intermediate values of the ranges of “about 5 wt. % to about 25 wt. %,” etc.). Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of coating an interior surface of a container, comprising: depositing a barrier film on the interior surface of the container using inductively coupled plasma-enhanced chemical-vapor deposition.

2. The method of claim 1, further comprising positioning a conductive coil around a body of the container and moving the conductive coil in parallel to a central axis of the container while supplying a radio frequency power to the conductive coil.

3. The method of claim 1, further comprising pumping reactive gases into the container.

4. The method of claim 2, further comprising pumping water though an interior of the conductive coil to cool the conductive coil.

5. The method of claim 1, further comprising pumping exhaust gas from the container.

6. The method of claim 3, wherein the reactive gases are pumped through an inlet conduit having holes in its wall for distribution of the gases.

7. The method of claim 1, wherein the barrier film comprises a silicon-oxy-nitride.

8. The method of claim 1, wherein the barrier film has a thickness of about 10 nanometers to about 1,000 nanometers and a water transmission rate of less than about 0.5 g/m²/day.

9. A method of coating an interior surface of a container, comprising: depositing a barrier film within a deposition chamber, wherein a hollow interior portion of the container is the deposition chamber.

10. The method of claim 9, wherein said depositing is performed using inductively coupled plasma-enhanced chemical-vapor deposition.

11. The method of claim 9, further comprising pumping reactive gases into the hollow interior portion of the container.

12. The method of claim 9, further comprising positioning a conductive coil around a body of the container and moving the conductive coil in parallel to a central axis of the container while supplying a radio frequency power to the conductive coil.

13. The method of claim 11, wherein the reactive gases are pumped through an inlet conduit having holes in its wall for distribution of the gases.

14. The method of claim 9, wherein the barrier film comprises a silicon-oxy-nitride.

15. The method of claim 9, wherein the barrier film has a thickness of about 10 nanometers to about 1,000 nanometers and a water transmission rate of less than about 0.5 g/m²/day.

16. A device for concurrently coating interior surfaces of a plurality of containers, comprising: an array of plasma sources, wherein each plasma source comprises an inlet conduit for injecting reactants into each container, an outlet conduit for pumping gas from said each container, and a conductive coil coupled to a radio frequency power supply.

17. The device of claim 16, wherein the device is capable of concurrently depositing a barrier film on each of the interior surfaces.

18. The device of claim 16, wherein the device is capable of positioning each conductive coil around a corresponding container and moving said each conductive coil in parallel to a central axis of said each container while supplying a radio frequency power to said each conductive coil.

19. The device of claim 16, wherein each inlet conduit comprises a plurality of holes for gas distribution.

20. The device of claim 16, wherein said each container comprises a hollow interior portion for acting as a deposition chamber.
